(19) United States
(12) Patent Application Publication
(10) Pub. No.: US 2024/0124238 A1
(43) Pub. Date: Apr. 18, 2024

(54) LIFT ASSEMBLY FOR BLOCKS AND METHOD OF LIFTING BLOCKS

(71) Applicant: Construction Specialties, LLC, Framingham, MA (US)

(72) Inventor: Thomas F. Donnelly, Wilmington, NC (US)

(21) Appl. No.: 17/965,424

(22) Filed: Oct. 13, 2022

(51) Int. Cl. B65G 7/12

(52) U.S. Cl. CPC B65G 7/12

(57) ABSTRACT

Lifting apparatus for lifting, conveying and/or positioning blocks or slabs, such as blocks or slabs made of concrete, masonry, stone, brick, or similar materials, and methods of lifting, conveying and/or positioning such materials. The lifting apparatus may include a main frame, a pair of gripper legs and gripper shoes of various thicknesses.

### BACKGROUND

Retaining walls are used for sites that feature difficult sloping terrain and where there is a need to maintain maximum developable area, earthen formations, or for locations requiring abrupt grade change, such as bridge abutments. Ideally, retaining wall systems are easy to stage and install, reduce construction time and costs and provide long-term durability, performance and structural integrity. They can address both structural and landscaping needs in a wide variety of markets, including transportation, industrial, commercial and residential markets.

These systems can be used in a wide range of applications, including the construction of large structural walls to small-tiered gardens. The blocks may be made of a variety of materials, including machine made concrete, pre-cast, natural stone and masonry. Segmental concrete retaining wall units typically may be dry stacked (built without mortar).

To construct retaining walls, the blocks are typically stacked on top of one another in a staggered fashion to enhance the strength of the wall; for example a block may be placed on top of two underlying blocks in an overlapping arrangement so that about half of the upper block rests on one of the underlying blocks and the remaining half of the upper block rests on the other underlying block. Other arrangements are also possible.

In view of the number of blocks that must be conveyed and positioned to construct a wall, and the weight of such blocks, mechanical lifting devices would be helpful to facilitate the foregoing. Conventional lifting apparatus typically includes gripper members that are positioned to frictionally engage opposite outer sides of a block. Upon raising the lifting apparatus, the block is lifted off the ground or off a supporting surface, and can be conveyed and positioned where desired. Once positioned, the gripper members of the lifting apparatus may be released from engagement with the block. Some blocks have built-in attachment elements that connect to the lifting apparatus for this purpose.

However, such friction-based systems are prone to failure, often due to the variable and unpredictable nature of the blocks and/or lifting apparatus, as well as the uneven or unstable terrain over which the blocks are often carried.

It would be desirable to provide an apparatus for concrete blocks, stone, masonry blocks and the like that facilitates the lifting, conveying and/or positioning of said materials, as well as a method of lifting, conveying and/or positioning the same. It also would be desirable to provide modular assemblies comprised of a plurality of lifting apparatuses that cooperate with one another to lift, convey and/or position a plurality of blocks or slabs. It still further would be desirable to provide a lifting apparatus and method of lifting blocks wherein a gripping shoe or shoes that engage the blocks may be selected based on the thickness of the rear wall of the block to be lifted, wherein that thickness is defined by the region between the outer rear wall of the block and the opposite wall in the inner core of the block.

These and other objects and advantages of the embodiments disclosed herein and advantageous features thereof will become apparent as the description proceeds herein.

### SUMMARY

Problems of the prior art have been addressed by the embodiments disclosed herein. Embodiments relate to a lifting apparatus for mechanically lifting, conveying and/or positioning blocks or slabs, such as blocks or slabs made of concrete, masonry, stone, brick, or similar materials, and methods of mechanically lifting, conveying and/or positioning such materials, such as to form or construct a wall, e.g., a retaining wall that provides structural integrity.

In some embodiments, the lifting apparatus includes two or more spaced block supporters, one or more positioned or positionable to mechanically support the underside of a block or slab, and one or more positioned or positionable to press against an internal or external wall of the block or slab. In some embodiments, one or more of the block supporters accesses the internal wall of the block or slab through a void region or core in the block or slab, and one or more of the supporters accesses the underside of the block or slab alongside an exterior wall of the block or slab. In another embodiment, all of the supporters access the underside of the block or slab alongside a respective exterior wall of the block or slab. In yet another embodiment, all of the supports access the underside of the block or slab through one or more internal or interior void regions or cores in the block or slab, defined by one or more interior walls. In some embodiments, upon biasing oppositely positioned block supporters towards each other, the block is engaged and supported by the assembly, and may be lifted, conveyed and/or positioned at a desired location. In some embodiments, the one or more of the spaced block supporters support the full weight of the block (e.g., half or some of the weight is supported vertically by the rear gripper foot and the remaining weigh is pivoted from the gripper foot and applied laterally towards the pressure pads. Unbiasing the block supporters releases the block.

In some embodiments, the lifting apparatus can be arranged in modular form, or a plurality of lifting apparatus can be integral or permanently attached. In such embodiments, more than one lifting apparatuses cooperate to lift, convey and/or transport a plurality of blocks or slabs. In some embodiments, the plurality of blocks or slabs are lifted at the same time. In other embodiments, the plurality of blocks or slabs are lifted at different times. In some embodiments, the plurality of blocks or slabs are lifted at the same time but not all of the plurality are disengaged at the same time; e.g., one or more of the plurality of blocks may be positioned and disengaged at a different time than other blocks of the plurality of blocks.

Accordingly, disclosed is a lifting apparatus that in some embodiments comprises a main frame; a gripper leg pivotably coupled to said main frame, said gripper leg having a gripper shoe; an actuator pivotably coupled to said gripper leg; a gripper leg spreader having a first gripper leg spreader shoe and a second gripper leg spreader shoe spaced from said first gripper leg spreader shoe, said gripper leg spreader being coupled to said actuator; wherein said first and second gripper leg spreader shoes are movable by said actuator with respect to said gripper shoe between a first position and a second position.

In some embodiments, the gripper shoe extends farther below the main frame than the first gripper leg.

In some embodiments, the lifting apparatus includes a locking arm positioned to lock to a second lifting apparatus.

In some embodiments, the lifting apparatus includes a third locking arm positioned to lock to a third lifting apparatus.

In some embodiments, one or more of the gripper leg spreader shoes and gripper shoe are removable and may be interchangeable.

In some embodiments, there are a plurality of interchangeable gripper leg spreader shoes and a plurality of interchangeable gripper shoes. The shoes within each plurality may be differentiated by thickness.

In another embodiment, a lifting apparatus comprises a main frame; a first gripper leg pivotably coupled to the main frame, the first gripper leg having a first gripper foot mount and a first gripper shoe removably attached to the first gripper foot mount; a second gripper leg pivotably coupled to the main frame, said second gripper leg having a second gripper foot mount and a second gripper shoe removably attached to the second gripper foot mount; wherein the first and second gripper legs are movable with respect to the main frame between a first position and a second position.

In some embodiments, the lifting apparatus further comprises a locking arm positioned to lock to a second lifting apparatus. In some embodiments, the lifting apparatus further comprises a second locking arm positioned to lock to a third lifting apparatus. In some embodiments, more than three (e.g., four, five, six, etc.) lifting apparatuses may be locked together with suitable locking arms.

In some embodiments, the lifting apparatus of this another embodiment further comprises a locking pin for locking the lifting apparatus in the first position or the second position. The locking pin may be used to manually actuate the apparatus between the first and second positions.

In some embodiments, the lifting apparatus of this another embodiment includes a third gripper shoe configured to interchangeably attach to the first gripper foot mount with the first gripper shoe. The third gripper shoe may have a thickness different from a thickness of the first gripper shoe. The gripper shoes may be selected based on the thickness of the region of the block between the outer wall and the core wall facing that outer wall, such that upon actuating the apparatus to its block engaged position, sufficient pressure is applied by the shoes to the block to engage, lift and convey the block, and in some embodiments to keep the block in position mechanically supported on the rear gripper foot and shoe.

In its method aspects, embodiments disclosed herein include a method of lifting, conveying and/or positioning a block or slab having an internal void or core, comprising: positioning a first block supporter of a lifting apparatus in an internal void or core of the block or slab, the internal void or core being defined by at least one inner or internal wall of the block or slab; positioning a second block supporter of a lifting apparatus alongside or near an external wall of the block or slab, the first and second supporters being in a first block release position; moving the first and second supporters to a second block engage position underneath the block or slab, biasing the first and second block supporters towards each other, thereby moving the first and second supporters underneath the block or slab to a block or slab supporting position; and raising the lifting apparatus to mechanically lift the block or slab off of a surface. The block may be conveyed to a predetermined location and released from the first and second supporters. These steps may be repeated a plurality of times with a plurality of blocks so as to construct a structure such as a wall, for example, such as a retaining wall.

In another embodiment, steps are the same except that both block supporters are positioned in the same or different internal voids or cores of the block or slab, and the gripper spreader shoes and gripper shoe are biased away from each other so that they each locate underneath the block in a block supporting position. The block may be conveyed and positioned to a desired location and released from the device. This operation may be repeated to construct a wall composed of a plurality of blocks arranged in predetermined arrays or patterns, for example. The block may be solid; e.g., it may be a block without a core or void. In some embodiments, the method includes lifting, conveying and/or positioning a plurality of blocks or slabs with a plurality of lifting apparatuses that are integral or are assembled in modular form and cooperate to simultaneously lift and convey the plurality of blocks or slabs. The gripper shoes may be interchanged such as by choosing the shoe or shoes with the appropriate thickness(es) based on the configuration of the block to be gripped and conveyed so as to effectively grip and mechanically support the block.

In yet another embodiment, embodiments disclosed herein include a method of configuring a lifting apparatus to lift a block having a bottom, an outer wall and an internal core having a core wall opposite the outer wall, the lifting apparatus having a first gripper leg pivotably coupled to a main frame, the first gripper leg having a first gripper foot mount; and a second gripper leg pivotably coupled to the main frame, the second gripper leg having a second gripper foot mount; the first and second gripper legs being movable with respect to each other between a block engaged position and a block unengaged position, the method comprising:
selecting a first gripper shoe having a first thickness and being attachable to the first gripper leg mount and a second gripper shoe having a second thickness and being attachable to the second gripper leg mount;
attaching the first gripper shoe to the first gripper leg mount;
attaching the second gripper shoe to the second gripper leg mount;
introducing the first gripper shoe into the inner core;
positioning the second gripper shoe to contact the outer wall and the bottom of the block;
moving the first and second gripper legs relative to each other to the block engaged position, the first and second thicknesses being sufficient so that the first gripper shoe biases against the core wall and mechanically forces the block against the second gripper leg and on top of and mechanically supported by the second gripper shoe thereby supporting the underside of the block.

In some embodiments, the first gripper shoe is selected from a plurality of gripper shoes having different thicknesses, different lengths, or both. In some embodiments, the second gripper shoe is selected from a plurality of gripper shoes having different thicknesses, different lengths, or both. In some embodiments, both the first and the second gripper shoes are selected from a plurality of gripper shoes having different thicknesses, different lengths, or both.

### BRIEF DESCRIPTION OF THE DRAWINGS

FIG. 1A is an exploded view of a lifting apparatus in accordance with certain embodiments;

FIG. 1B is a perspective view of the lifting apparatus of FIG. 1A;

FIG. 2 is a first side view, in perspective, of a lifting apparatus engaging a block in accordance with certain embodiments;

FIG. 3 is a second side view, in perspective, of a lifting apparatus engaging a block in accordance with certain embodiments;

FIG. 4 is a rear view of a lifting apparatus engaging a block in accordance with certain embodiments;

FIG. 5 is a bottom view of a lifting apparatus engaging a block in accordance with certain embodiments;

FIG. 6 is a front view of a lifting apparatuses engaging a block in accordance with certain embodiments;

FIG. 7 is a perspective view of a lifting apparatuses engaging a block in accordance with certain embodiments;

FIG. 8A is a top view of a lifting apparatus frame in accordance with certain embodiments;

FIG. 8B is a rear view of the lifting apparatus frame of FIG. 8A;

FIG. 9A is a side view of a gripper leg in accordance with certain embodiments;

FIG. 9B is a rear view of the gripper leg of FIG. 9A;

FIG. 9C is a front view of a gripper foot mount in accordance with certain embodiments;

FIG. 10A is a perspective view of a gripper leg spreader in accordance with certain embodiments;

FIG. 10B is a front view of the gripper leg spreader of FIG. 10A;

FIG. 10C is a side view of the gripper leg spreader of FIG. 10A;

FIG. 10D is a side view of an actuator plate in accordance with certain embodiments;

FIG. 11 is a side view of a pivot arm in accordance with certain embodiments;

FIG. 12A is a side view of a lock arm in accordance with certain embodiments;

FIG. 12B is a perspective view of the pivot and locking arms in pivotable engagement in accordance with certain embodiments;

FIG. 13A is a bottom perspective view of a lifting apparatus coupled to a block in accordance with certain embodiments;

FIG. 13B is another bottom perspective view of a lifting apparatus coupled to a block in accordance with certain embodiments;

FIG. 13C is yet another bottom perspective view of a lifting apparatus engaged with a block in accordance with certain embodiments;

FIG. 13D is a still further bottom perspective view of a lifting apparatus engaged with a block in accordance with certain embodiments;

FIG. 14 is a perspective view of a plurality of lifting apparatuses gripping respective blocks in accordance with certain embodiments;

FIG. 15 is a perspective view of a lifting apparatus in accordance with an alternative embodiment;

FIG. 16 is a perspective view of a lifting apparatus frame in accordance with the embodiment of FIG. 15;

FIG. 17A is a perspective view of a gripper leg in accordance with the embodiment of FIG. 15;

FIG. 17B is a rear view of a gripper leg of FIG. 17A;

FIG. 18A a perspective view of another gripper leg in accordance with the embodiment of FIG. 15;

FIG. 18B is a rear view of the gripper leg of FIG. 18A; and

FIG. 19 is a perspective view of a lifting apparatus engaged with a block in accordance with another alternative embodiment.

### DETAILED DESCRIPTION

A more complete understanding of the components, processes and devices disclosed herein can be obtained by reference to the accompanying drawings. The figures are merely schematic representations based on convenience and the ease of demonstrating the present disclosure, and is, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification, various devices and parts may be described as “comprising” other components. The terms “comprise(s),” “include(s),” “having,” “has,” “can,” “contain(s),” and variants thereof, as used herein, are intended to be open-ended transitional phrases, terms, or words that do not preclude the possibility of additional components.

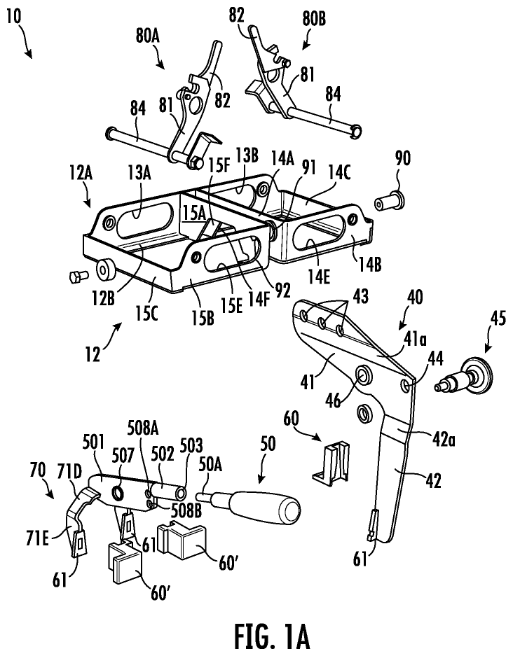

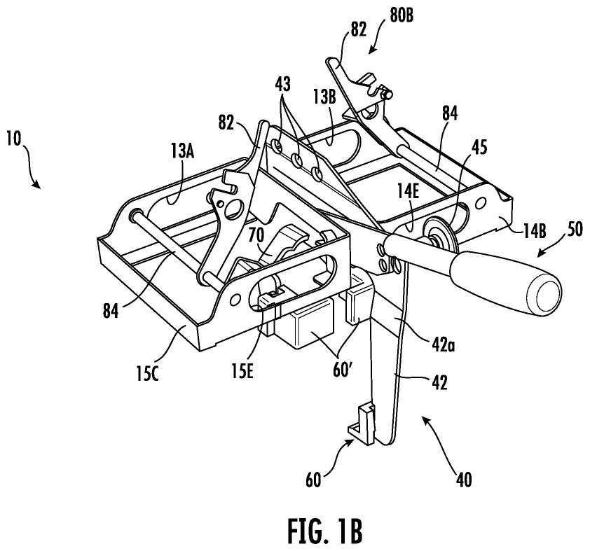

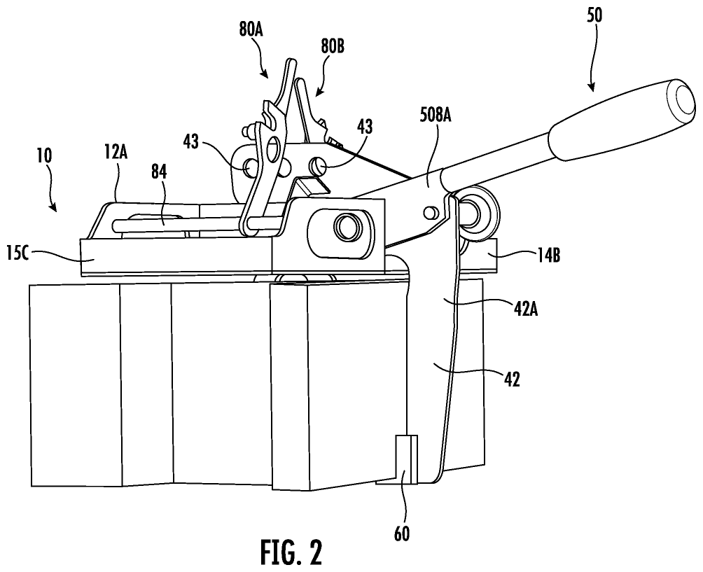

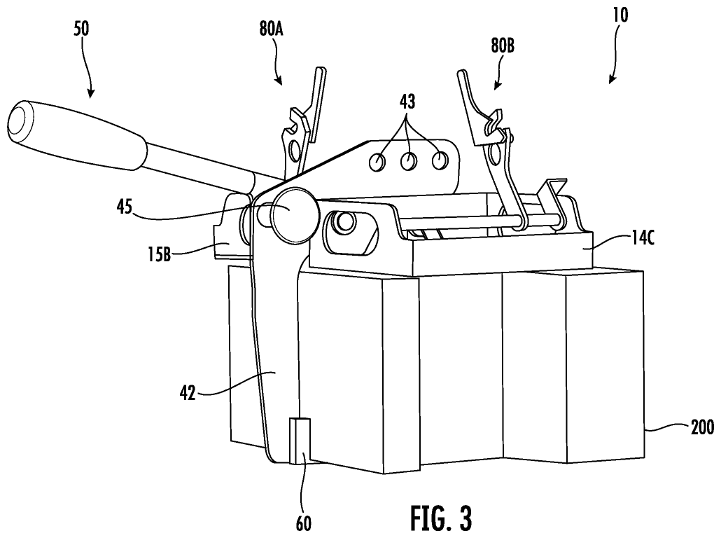

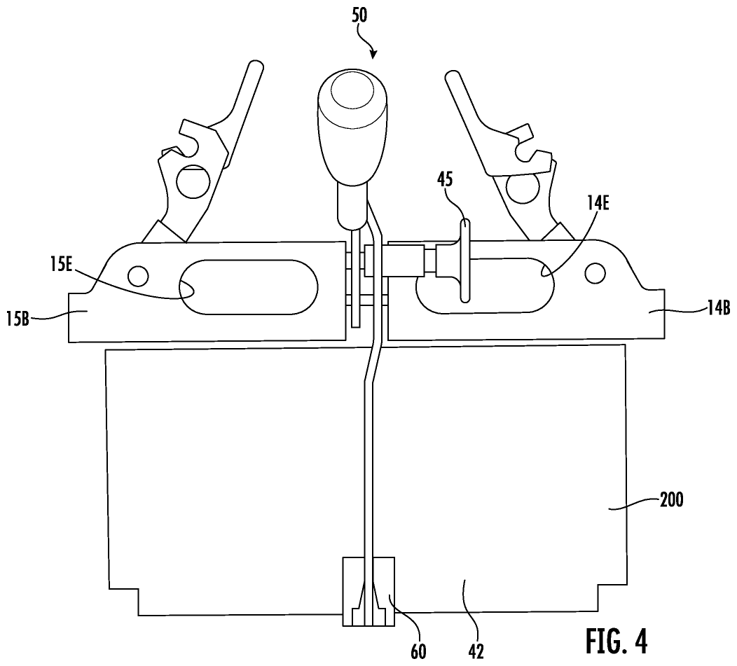

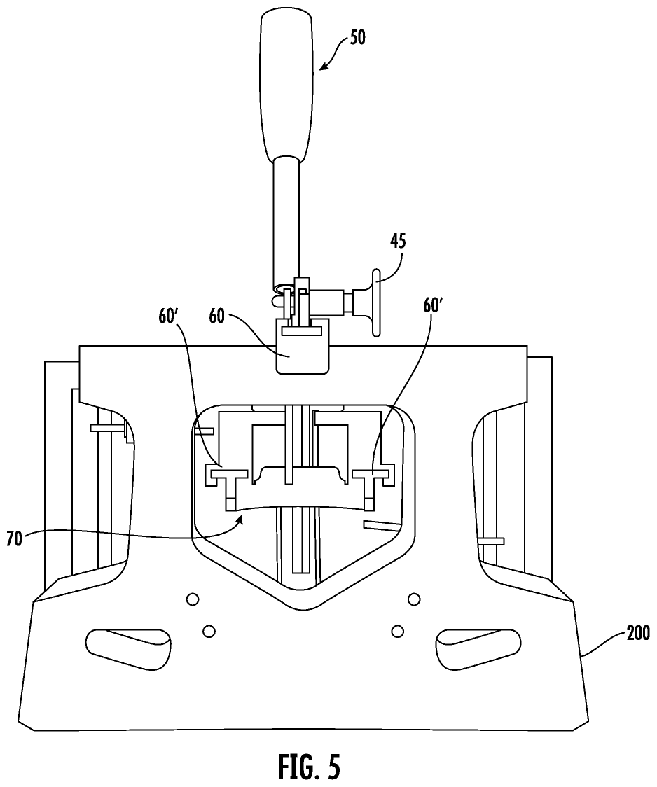

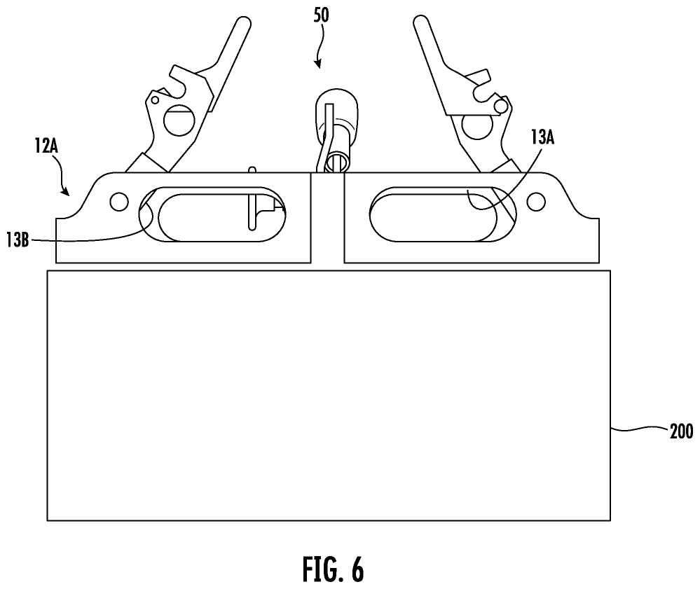

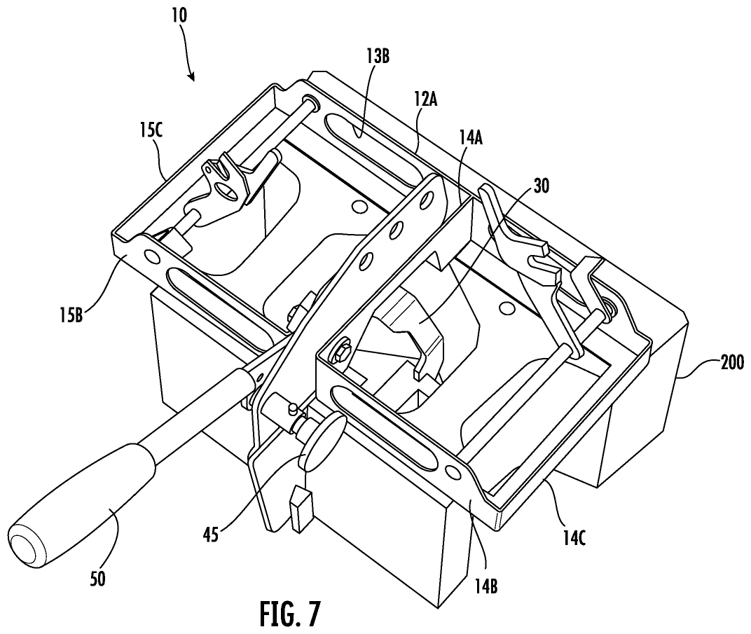

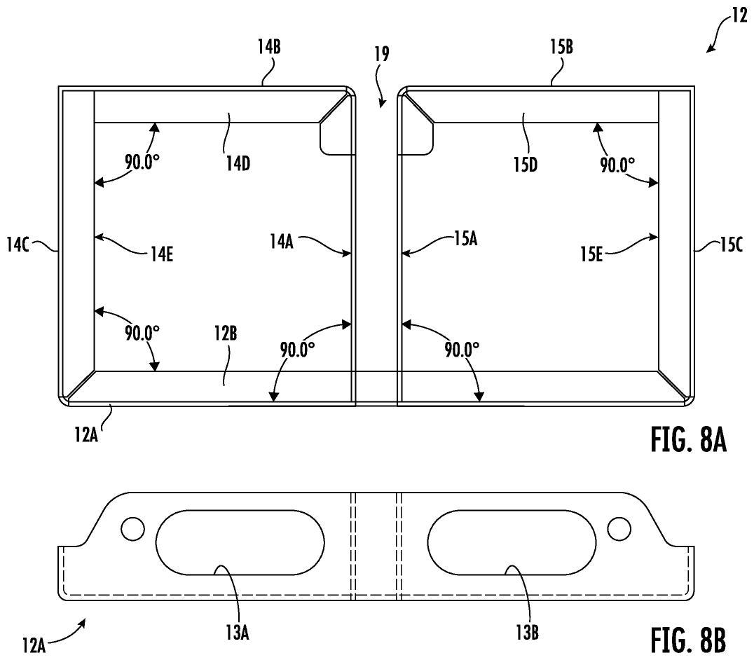

Turning now to FIGS. 1A, 1B and 2-8, there is shown one embodiment of a lifting apparatus 10. In the embodiment shown, there is a main frame 12 that may include one or more apertures configured and positioned to receive one or more respective components of the apparatus as discussed below. The frame 12 may be a unitary structure or may be formed from a plurality of separate parts coupled together such as by welding or with suitable fasteners. A preferred material of construction of the frame 12 is aluminum due to its light weight and strength, although other materials are also suitable including steel or stainless steel, plastics, composites, etc. for example. As seen in FIGS. 8A and 8B, in the embodiment shown the frame 12 includes an elongated rear frame member or bar 12A having optional cutouts 13A, 13B (e.g., oval-shaped cutouts) to reduce weight, and a bottom flange 12B that extends inwardly when in the assembled condition. The number and shapes of the cutouts is not particularly limited. The frame 12 also includes two spaced transverse bars 14A and 15A, preferably coupled at one end to the rear frame member 12A such as by welding. In some embodiments, the bars 14A, 15A may each by generally U-shaped, with transverse bar 14A including front bar 14B and side bar 14C, and transverse bar 15A including front bar 15B and side bar 15C as shown. Alternatively, the bars 14A, 15A may be bent extend to respective rear corners of the main frame where they may be secured such as by welding. Front bars 14B, 15B may include respective cutouts 14E, 15E (e.g., oval-shaped cutouts, FIG. 1) to reduce weight and provide additional grasping points for the user. Again, the number and shapes of the cutouts is not particularly limited. Side bars 14C and 15C each may be respectively integral with, or coupled to, rear frame member 12A. Some or all of front bars 14B and 15B, and side bars 14C and 15C, also may include respective bottom flanges 14D, 14E and 15D and 15E that each extend inwardly when in the assembled condition. The region between the spaced bars 14A, 15A defines a channel 19 for accommodating other components of the device including an actuator assembly including a preferably removable actuator 50 as discussed in greater detail below. Each transverse bar 14A, 15A may include a generally trapezoidal cutout 14F, 15F to accommodate a gripper leg spreader 70 as discussed in greater detail below.

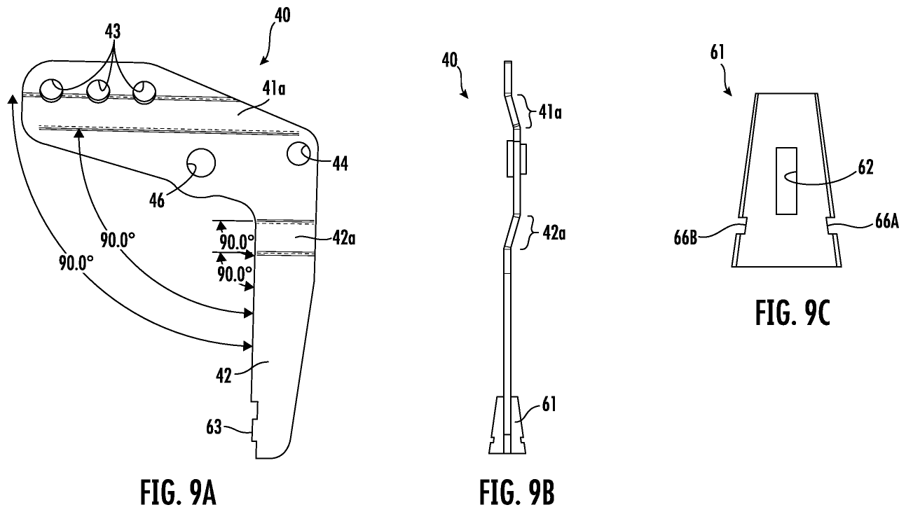

FIGS. 1A, 9A and 9B illustrate a gripper leg 40 in accordance with certain embodiments. In some embodiments, the gripper leg 40 is an integral or unitary member and includes a main body region 41 and a leg 42 extending therefrom preferably at one end thereof. The main body region 41 may include one or more through-holes 43 (three shown) that may be used for attachment to a lifting chain or the like (not shown). When more than two through-holes 43 are present, they may be linearly aligned. A further through-hole 44 is positioned in the main body region 41 to accommodate locking pin 45, which may be spring-loaded. A still further through-hole 46 may be positioned in the main body region 41 to pivotably connect the gripper leg 40 to the main frame 12 such as with pin 90 that inserts through holes 91, 92 in the main frame 12 and which also attaches the actuator assembly. As seen best in FIG. 9B, the gripper leg 40 may be a bent member (to accommodate for the thickness of the bushings and allow the lift points to be brought back to the center of gravity on the block, allowing for a balanced block when suspended in the air and positioned in e), with a first bent region 41a in the main body region 41 and a second opposite bent region 42a in the leg 42. The leg 42 terminates in a gripper foot mount 61 (FIG. 9C) which may have a central opening 62 that receives a corresponding tab 63 formed in the leg 42. Opposite perimeter slots 66A, 66B are formed in the gripper foot mount 61 are positioned and configured to receive gripper shoe 60. Preferably gripper shoe 60 is L-shaped as shown, and includes on its rear wall a slot or groove shaped to be slidingly received by a similarly shaped gripper foot mount 61, such as in interlocking engagement. The width of the slot or groove may be modified or adjusted to control the extent to which the shoe 60 slides onto the gripper mount 61, thereby controlling the distance the shoe 60 extends downwardly from the gripper leg 40. This allows blocks with different configurations and/or thicknesses of rear walls to be accommodated. A set screw or the like may be used to lock the shoe 60 onto the mount 61, and thus the gripper shoe 60 may be removable, allowing different sized gripper shoes to be attached to the gripper foot mount 61. This further adds to the versatility of the apparatus, enabling it to be used with blocks with rear walls of different thicknesses, for example. Thinner rear block walls will require thicker gripper shoes 60; thicker rear block walls will require thinner gripper shoes 60.

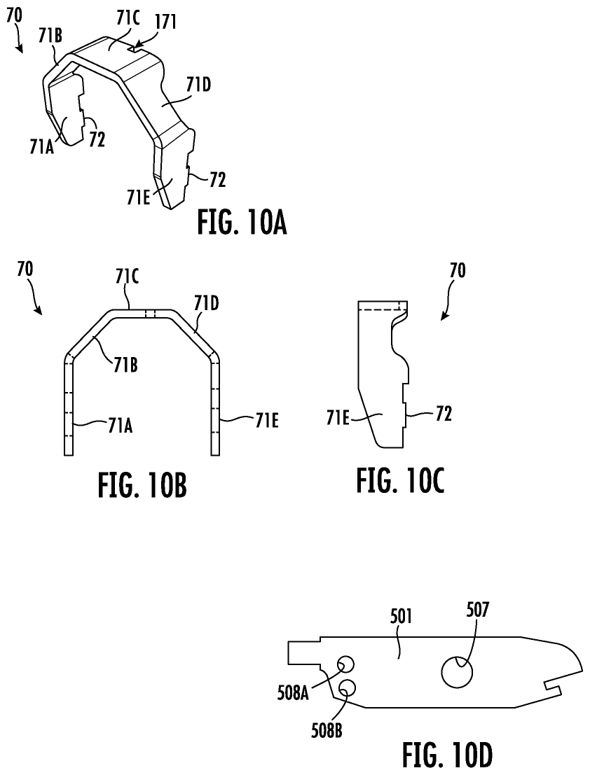

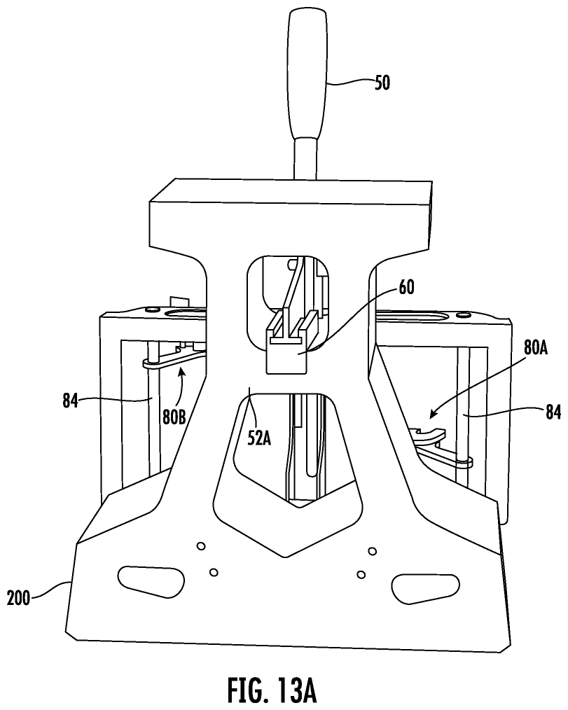

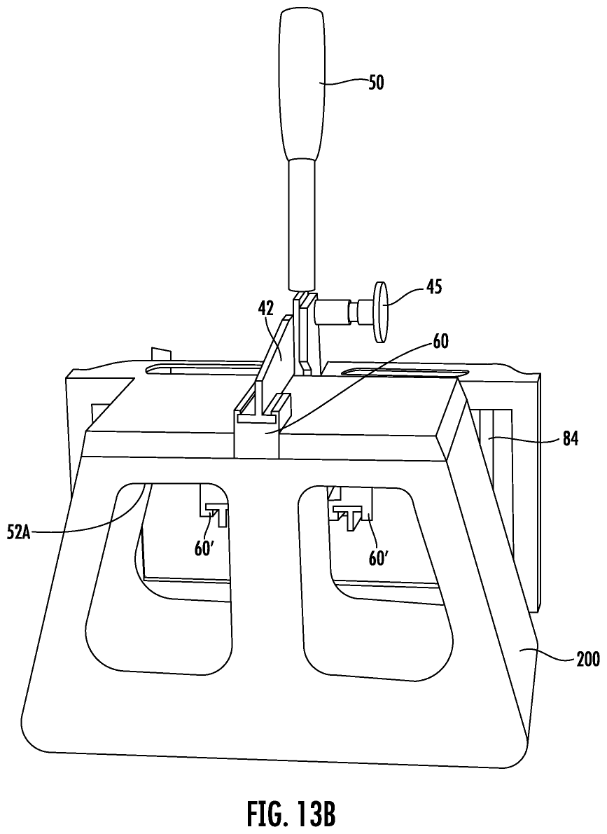

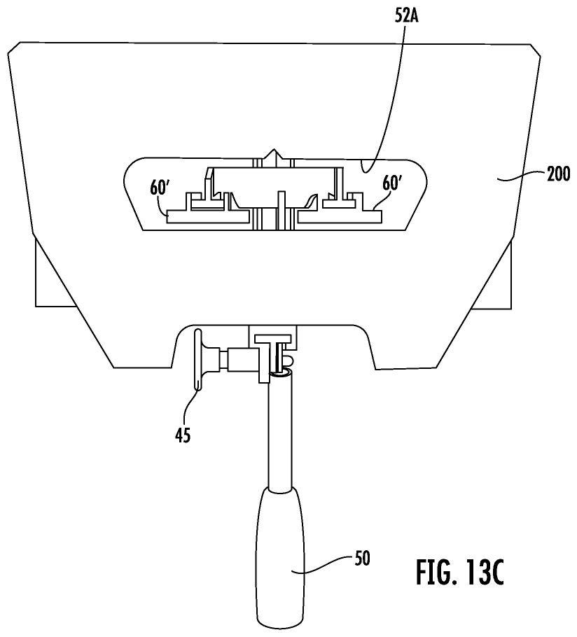

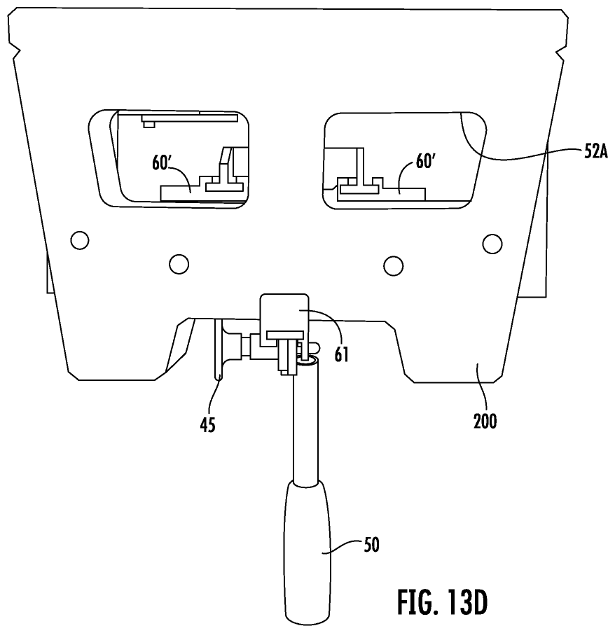

FIGS. 10A, 10B and 10C illustrate a gripper leg spreader 70 in accordance with certain embodiments. In some embodiments the gripper leg spreader 70 is a unitary structure, and may be made of aluminum or other suitable material such as steel or stainless steel, plastics, composites, etc. In some embodiments it is generally U-shaped and symmetrical, with a first slanted leg 71A having a free end, a first angled piece 71B, a top piece 71C having notch 171, a second angled piece 71D and a second slanted leg 71E having a free end. Each of the slanted legs 71A, 71E includes a tab 72 or the like that is received by opening 62 in gripper foot mount 61 (FIG. 9C). Each gripper foot mount 61 receives, e.g., in interlocking engagement, a respective gripper shoe 60′, which also may be generally L-shaped. In the embodiment shown in FIG. 1A, there is one left shoe with the L-shape pointing to the left, and one right shoe with the L-shape pointing to the right. Notch 171 is positioned and configured to receive actuator plate 501 (FIG. 10D), which includes a tubular receiver or conduit 502 having a bore 503 configured to receive stem 50A of actuator handle 50 (FIG. 1A). In some embodiments, the actuator plate 501 includes a first through hole 507 that receives a bushing and functions as the pivot point that a pivoting pin is inserted into. Through holes 508A and 508B are configured and positioned to receive the locking pin to respectively place the unit in an open/unlocked/disengaged position to a closed/locked/engaged position. In some embodiments, the actuator handle 50 may be inserted into the receiver 502 when keyways are aligner and then rotated to prevent removal. A set screw may be tightened to prevent the actuator handle 50 from rotating and aligning the keyways. Removal of the actuator handle 50 may be performed loosening the set screw, rotating the actuator handle 50 to align the keyways and linearly retracting the actuator handle 50 from the receiver 502. Typically removal is only performed when the units are to be stored for shipping to the job site. Otherwise, they may remain installed during operation. The spacing between the two gripper shoes 60′ is preferably small enough so that both gripper shoes 60′ can be positioned in a single core of a block 200; in other words, in blocks 200 with a single core (FIG. 13C), the length of the core is such that it accommodates both gripper shoes 60′. Alternatively, a single shoe could be used, in which case the gripper leg spreader 70 need not be U-shaped; it may have a single leg terminating in a free end where the gripper foot mount is positioned. In embodiments where the block 200 has two cores (e.g., FIGS. 13A, 13B and 13D), the spacing between the two cores is such that one gripper shoe 60′ can be positioned in one of the cores, and the other gripper shoe 60′ can be positioned in the other core. In some embodiments, the shoes 60 and 60′ may be made of mild steel.

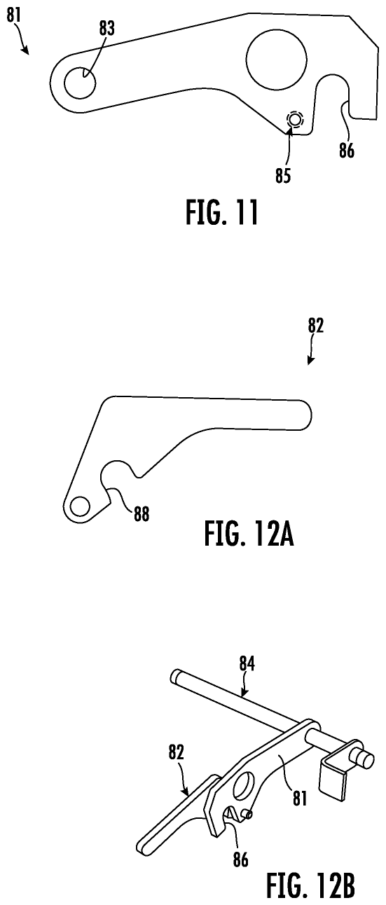

Turning to FIGS. 1A, 1B, 11, 12A and 12B, an embodiment of locking arm assemblies 80A, 80B is shown. The locking arm assemblies 80A, 80B may be identical in shape, and each may include a respective pivot arm 81 and a lock arm 82 pivotably coupled thereto. Each pivot arm 81 includes a first aperture 83 configured to receive rod 84, second aperture 85 configured to receive a pivot pin or the like to pivotably attach lock arm 82 to the pivot arm 81, and groove or cut-out 86 configured to receive a rod from an adjacent second lift assembly (not shown). Lock arm 82 includes groove or cut-out 88 configured to receive the same rod from an adjacent lift assembly Actuation of the lock arm 82 pivots the pivot arm 81 by rotating the rod 84 to which it is coupled and locks an adjacent second lift assembly by engaging with the rod 84 of that adjacent lift assembly. The locking arms may be omitted or positioned in a non-obstructive manner if only a single unit is going to be used.

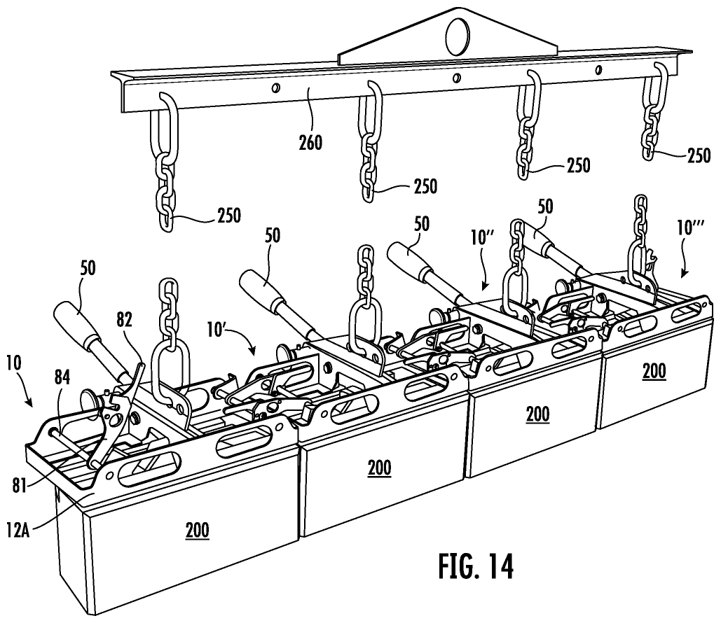

In some embodiments, a plurality of lifting apparatuses may be assembled in modular form. In some embodiments two or more lifting apparatus may be positioned in side-by-side relation with one main frame 12 of a first lifting apparatus abutting against or juxtaposed to one main frame 12 of a second lifting apparatus, as seen in FIG. 14. When two lifting apparatuses 10, 10′ are positioned in side-by-side relation, the two lifting apparatuses may be coupled together such as by actuating the respective locking arms 80A, 80B to engage respective rods 84 on adjacent apparatuses. While four lifting apparatuses 10, 10′, 10″ and 10′″ are shown in FIG. 14, the number of lifting apparatuses that can be coupled together is not limited.

Alternatively, a plurality of lifting apparatuses may be integral or permanently coupled together in side-by-side relation.

In some embodiments, it is advantageous to couple four lifting apparatus together (or use a single integral unit having four lifting mechanisms) so as to simultaneously lift a plurality of blocks or slabs, such as four blocks or eight blocks. In other embodiments, a plurality of lifting apparatuses coupled together in modular form may be used together with a second plurality of lifting apparatuses to lift, convey and/or position a plurality of blocks arranged in two rows such that the blocks in a first row face the blocks in a second row (i.e., are arranged front-to-front (face-to-face)), or arranged in two rows such that the blocks in a first row butt the blocks in second row (i.e., are arranged back-to-back). Preferably the number of lifting apparatuses in the first plurality or row matches the number of lifting apparatuses in the second plurality or row. In a particularly preferred embodiment, there are four lifting apparatuses in each of the first and second rows or plurality of lifting apparatuses, enabling the simultaneous lifting, conveying and/or positioning of eight blocks or slabs. This is especially advantageous since often the blocks or slabs are delivered on pallets in layers or stacks of eight, and thus this particular assembly of lifting apparatuses allows for the lifting of an entire layer of blocks at the same time. Thus, for example, four blocks can be positioned at once, and then the assembly may be rotated 180° to position the remaining four blocks.

An alternative embodiment is shown in FIG. 15. In the embodiment shown, there is a lifting apparatus 100 including a main frame 112 that may include one or more apertures configured and positioned to receive one or more respective components of the apparatus as discussed below. The frame 112 may be a unitary structure or may be formed from a plurality of separate parts coupled together such as by welding or with suitable fasteners. A preferred material of construction of the frame 112 is aluminum due to its light weight and strength, or structural steel. In the embodiment shown the frame 112 includes an elongated rear frame member or bar 112A having optional cutouts 113A, 113B, etc. (e.g., circular-shaped cutouts) to reduce weight, and a bottom flange 112B that extends inwardly when in the assembled condition. The number and shapes of the cutouts is not particularly limited. The frame 112 also includes two spaced bent bars 114A and 115A, preferably coupled at one end to the rear frame member 112A, or to the corners formed by rear frame member 112A and respective side members 114C, 115C, such as by welding. The bent bars 114A, 115A also form the front of frame 112, and are positioned with respect to each other so as to define a channel 119 between them for accommodating other components of the device including an actuator assembly including an actuator handle with hand grip 151. Aligned through-holes 146 may be provided to accommodate a pin 190 or the like as discussed in greater detail below. Bent bars 114A, 115A may include respective cutouts (e.g., circular-shaped cutout) to reduce weight. Again, the number and shapes of the cutouts is not particularly limited. Side bars 114C and 115C also may include respective bottom flanges that each extend inwardly when in the assembled condition.

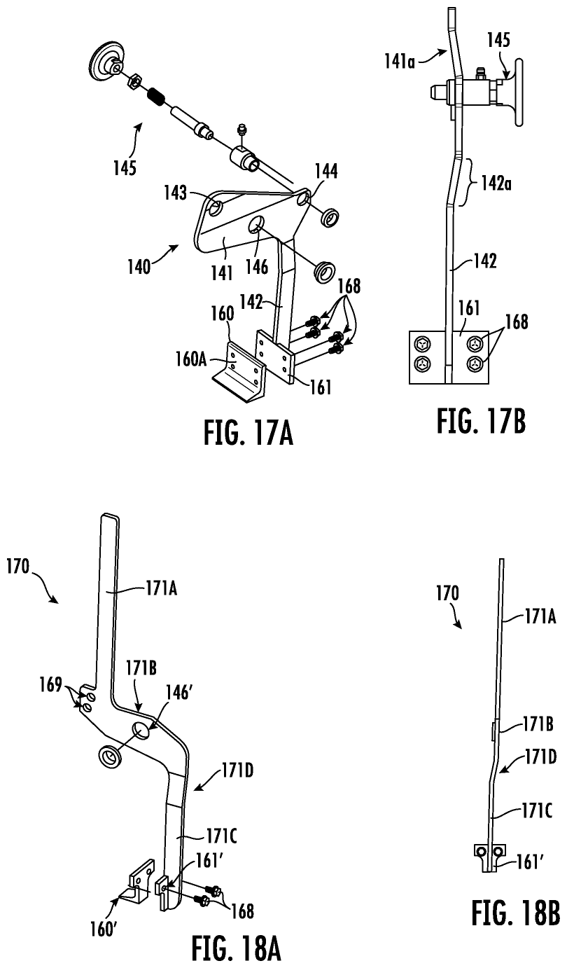

FIGS. 17A and 17B illustrates a gripper leg 140 in accordance with certain embodiments. In some embodiments, the gripper leg 140 is an integral or unitary member and includes a main body region 141 and a leg 142 extending therefrom preferably at one end thereof. The main body region 141 may include one or more through-holes 143 (one shown) that may be used for attachment (e.g., is attachable) to a lifting chain or tether. A further through-hole 144 is positioned in the main body region 141 to accommodate locking pin 145, which may be spring-loaded. A still further through-hole 146 may be positioned in the main body region 141 to pivotably connect the gripper leg 140 to the main frame 112 such as with pin 190 and which also attaches the actuator assembly. The gripper leg 140 may be a bent member, to accommodate for the thickness of the bushings and allow the lift points to be brought back to the center of gravity on the block. This allows for a balanced block when suspended in the air, with a first bent region 141a in the main body region 141 and a second opposite bent region 142a in the leg 142. The leg 142 terminates in a gripper foot mount 161 positioned and configured to receive gripper shoe 160, such as in interlocking engagement. Preferably gripper shoe 160 is L-shaped as shown, and includes on its rear wall one or more through-holes to receive fasteners 168 such as bolts to secure it to foot mount 161. Different sized gripper shoes 160 may be attached to the gripper foot mount 161. This adds to the versatility of the apparatus, enabling it to be used with blocks with rear walls of different thicknesses, for example. Thinner rear block walls will require thicker gripper shoes 160; thicker rear block walls will require thinner gripper shoes 160. In some embodiments, two or more spaced gripper foot mounts 161 with respective gripper shoes 160 may be used instead of a single gripper foot mount.

FIGS. 18A and 18B illustrates gripper leg 170 in accordance with certain embodiments. In some embodiments the gripper leg 170 is a unitary structure, made of a suitable material such as aluminum or structured steel, for example. In some embodiments it has a first arm 171A having a free end, a main body region 171B, and a leg 171C having a bent region 171D and free end. The main body region 171B includes a through hole 146′ positioned in the main body region 171B to pivotably connect the gripper leg 170 to the main frame 112 such as with pin 190 and which also attaches the actuator assembly. The main body region 171B also includes one or more through-holes 169 to receiving a locking pin to lock the gripper leg 170 into first and second positions. The free end of leg 171C includes gripper foot mount 161′ configured to receive a respective gripper shoe 160′, which also may be generally L-shaped. Fasteners 168 such as bolts may be used to fasten the gripper shoe 160′ to the gripper foot mount 161′. First arm 171A functions as an actuator or handle and may include hand grip 151 to assist in actuating the gripper legs. In some embodiments, a flat pressure plate may be used instead of the gripper foot mount and gripper shoe, which functions to bias the block being engaged, lifted and conveyed onto and against the gripper shoe 160 of the gripper leg 140.

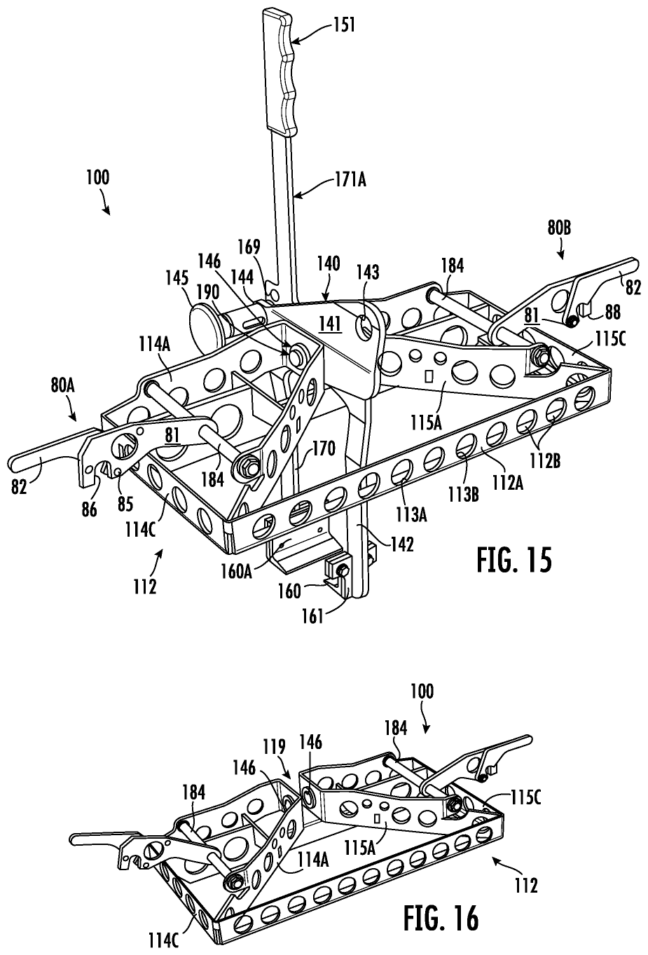

Like the embodiment of FIG. 1A, the embodiment of FIGS. 15-18 may include locking arm assemblies 80A, 80B as shown to attach multiple units together. The locking arm assemblies 80A, 80B may be identical in shape, and each may include a respective pivot arm 81 and a lock arm 82 pivotably coupled thereto. Each pivot arm 81 includes a first aperture 83 configured to receive a rod 184, second aperture 85 configured to receive a pivot pin or the like to pivotably attach lock arm 82 to the pivot arm 81, and groove or cut-out 86 configured to receive a rod from an adjacent second lift assembly (FIG. 14). Lock arm 82 includes groove or cut-out 88 configured to receive the same rod from an adjacent lift assembly. Actuation of the lock arm 82 pivots the pivot arm 81 by rotating the rod 84 to which it is coupled and locks an adjacent second lift assembly by engaging with the rod 84 of that adjacent lift assembly.

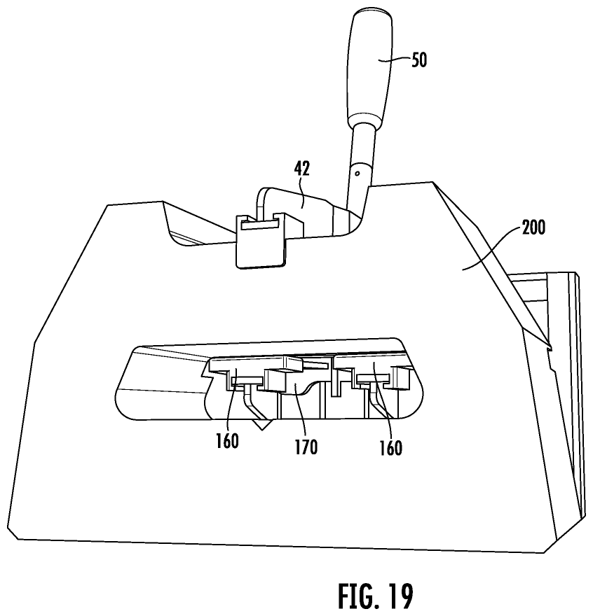

In the embodiment of FIG. 19, the gripper foot mounts and gripper shoes attached to gripper leg 170 may be spaced a greater distance apart to accommodate certain blocks with internal walls that are separate and accessible from the block sides, as shown.

The components of the lifting apparatus 10 may be made of any suitable rigid material strong enough to lift, convey and position blocks or slabs. One suitable material of construction is structural steel. Another suitable material of construction is sheet metal, such as 3/16″ or ¼″ inch thick sheet metal, that can be formed into the desired shapes to create an interlocking design, thereby eliminating some or all of the welding for assembly. Aluminum, plastics, fiberglass and combinations thereof also may be suitable.

Suitable blocks 200 or slabs that may be lifted, conveyed and/or positioned with the lifting apparatus 10 may have an internal void 52 defined by at least one internal wall 52A (FIGS. 13A, 13B, 13C and 13D), or a plurality of internal voids defined by a plurality of internal walls. Others may not have an internal void. Suitable blocks are blocks that are commercially available and used in civil engineering applications such as for retaining walls for earth retention, or in gardening or landscaping applications. Such blocks are available in various sizes, shapes and weights including, but not limited to, 8″h×18″w×12″d+/−, 8″h×12″w×11″d+/−, 16″h×6″w×12″d and 6″h×16″w×12′d′. The lifting apparatus(es) 10 may be used to position blocks or slabs in any of various arrays or patterns to construct retaining walls, for example. In some embodiments, the blocks are irregular; e.g., the front or face of the block may have a different configuration than the rear or back of the block.

In operation, in certain embodiments the lifting apparatus 10 may be positioned to engage a block or slab. The gripper leg spreader shoes 60′ are positioned in the one or more voids in aa block, and the gripper shoe 60 is positioned underneath the block. The block may now be lifted by raising a chain or other tether 250 (FIG. 14) coupled to the apparatus 10, such as with a motorized construction vehicle such as an excavator, skid steer loader, a crane, a tractor, a backhoe, etc. Where a plurality of lifting apparatuses are assembled in modular form, one or more of the chains may be attached to a common beam or spreader bar 260 or the like and the chains or tether 250 may be of the same length so that all of the blocks may be lifted simultaneously. Upon resting the block on a substrate, the load on the chain is mitigated or eliminated, and the respective gripper feet may be pivoted to their open position by actuating the actuator, thereby releasing the block. In this way, blocks may be conveyed one-by-one or in groups and placed in a predetermined pattern to form a structure such as a retaining wall.

In some embodiments, there are more than two gripper shoes available, with different thicknesses. That is, the thicknesses of the region 160A of the gripper shoe 160 (FIG. 15) configured to be coupled to the gripper mount 161 may differ among gripper shoes, so that the operator may select the gripper shoes with suitable thicknesses so that the distance between two opposing shoes when the gripper legs are in the block engaged position is sufficient engage, grip and convey the block, such as by forcing the block onto and against the gripper shoe that is engaging the block outer wall and bottom. For example, the thicknesses of the gripper shoes are chosen so that the gripper shoe that engages the inner core wall biases the block towards and against the gripper shoe that engages the outer wall when the gripper legs are in the block engaged position. In this way, the variability of the gripping force on the block is not directly controlled by varying the extent to which the gripper legs are manually actuated towards one another, but is instead controlled by modifying the distance between the two gripper shoes by selectively varying the thickness of the gripper shoes used. Thus the apparatus may have only two locked positions: the block disengaged position and the block engaged position, with variability in block sizes being accommodated by use of different sized gripper shoes rather than by different block engaged locking positions of the gripper legs.

In embodiments where multiple blocks are lifted with multiple lifting apparatuses, preferably the chains 250 for each lifting apparatus are attached to the same actuator (e.g., the same construction vehicle).

What is claimed is:

1. A lifting apparatus, comprising:
a main frame;
a first gripper leg pivotably coupled to said main frame, said first gripper leg having a first gripper foot mount and a first gripper shoe removably attached to said first gripper foot mount;
a second gripper leg pivotably coupled to said main frame, said second gripper leg having a second gripper foot mount and a second gripper shoe removably attached to said second gripper foot mount;
an actuator pivotably coupled to said first or said second gripper leg;
wherein said first and second gripper legs are movable by actuating said actuator with respect to said main frame between a first position and a second position.

2. The lifting apparatus of claim 1, further comprising a locking arm positioned to lock to a second lifting apparatus.

3. The lifting apparatus of claim 3, further comprising a second locking arm positioned to lock to a third lifting apparatus.

4. The lifting apparatus of claim 1, further comprising a locking pin for locking said lifting apparatus in said first position.

5. The lifting apparatus of claim 1, further comprising a locking pin for locking said lifting apparatus in said second position.

6. The lifting apparatus of claim 1, further comprising a third gripper shoe configured to interchangeably attach to said first gripper foot mount with said first gripper shoe.

7. The lifting apparatus of claim 6, wherein said third gripper shoe has a thickness different from a thickness of said first gripper shoe.

8. A lifting apparatus, comprising:
a main frame;
a first gripper leg pivotably coupled to said main frame, said first gripper leg having a first gripper foot mount and a first gripper shoe removably attached to said first gripper foot mount;
a second gripper leg pivotably coupled to said main frame, said second gripper leg having a pressure plate;
an actuator pivotably coupled to said first or said second gripper leg;
wherein said first and second gripper legs are movable by actuating said actuator with respect to said main frame between a first position and a second position.

9. A method of configuring a lifting apparatus to lift a block having a bottom, an outer wall and an internal core having a core wall opposite said outer wall, the lifting apparatus having a first gripper leg pivotably coupled to a main frame, said first gripper leg having a first gripper foot mount; and a second gripper leg pivotably coupled to said main frame, said second gripper leg having a second gripper foot mount; said first and second gripper legs being movable with respect to each other between a block engaged position and a block unengaged position, said method comprising:
selecting a first gripper shoe having a first thickness and being attachable to said first gripper leg mount and a second gripper shoe having a second thickness and being attachable to said second gripper leg mount;
attaching the first gripper shoe to the first gripper leg mount;
attaching the second gripper shoe to the secondo gripper leg mount;
introducing the first gripper shoe into the inner core;
positioning the second gripper shoe to contact the outer wall and the bottom of the block;
moving the first and second gripper legs relative to each other to the block engaged position, the first and second thicknesses being sufficient so that the first gripper shoe biases against the core wall and mechanically forces the block against the second gripper shoe to grasp and support the block.

10. The method of claim 9, wherein said first gripper shoe is selected from a plurality of gripper shoes having different thicknesses.

11. The method of claim 9, wherein said second gripper shoe is selected from a plurality of gripper shoes having different thicknesses.
